(19) United States
(12) Patent Application Publication
(10) Pub. No.: US 2016/0360236 A1
(43) Pub. Date: Dec. 8, 2016

(54) Method and Apparatus for Entropy Transcoding

(71) Applicant: MediaTek Inc., Hsin-Chu (TW)

(72) Inventors: Chao-Chih HUANG, New Taipei City (TW); Shen-Kai CHANG, Zhubei City (TW); Hung-Chih LIN, Caotun Township (TW)

(21) Appl. No.: 15/075,022

(22) Filed: Mar. 18, 2016

Related U.S. Application Data
(60) Provisional application No. 62/170,810, filed on Jun. 4, 2015.

(51) Int. Cl. H04N 19/91; H04L 29/06; H04N 19/60; H04N 19/13; H04N 19/51; H04N 19/124

(52) U.S. Cl. CPC H04N 19/91; H04N 19/51; H04N 19/124; H04N 19/60; H04N 19/13; H04L 65/607

(57) ABSTRACT

A method and apparatus for transcoding a compressed bitstream are disclosed. The system receives a first compressed bitstream generated by applying first entropy encoding to a set of tokens. The first compressed bitstream is decoded into the set of tokens using first entropy decoding corresponding to the first entropy encoding. The set of tokens is then re-encoded into a second compressed bitstream using second entropy encoding, where the second entropy encoding and the first entropy encoding use different statistics, different initial states, or both. The system may further comprising determining one or more modified or optimal probability models associated with the set of tokens, where the second entropy encoding is based on the modified or optimal probability models.

### CROSS REFERENCE TO RELATED APPLICATIONS

The present invention claims priority to U.S. Provisional Patent Application, Ser. No. 62/170,810, filed on Jun. 4, 2015. The U.S. Provisional Patent Application is hereby incorporated by reference in its entirety.

### FIELD OF THE INVENTION

The present invention relates to entropy coding for source data such as video and image data. In particular, the present invention relates to transcoding of entropy coded data using arithmetic coding to improve performance.

### BACKGROUND

Video data requires a lot of storage space to store or a wide bandwidth to transmit. Along with the growing high resolution and higher frame rates, the storage or transmission bandwidth requirements would be formidable if the video data is stored or transmitted in an uncompressed form. Therefore, video data is often stored or transmitted in a compressed format using video coding techniques. The coding efficiency has been substantially improved using newer video compression formats such as H.264/AVC, VP8, VP9 and the emerging HEVC (High Efficiency Video Coding) standard. In order to maintain manageable complexity, an image is often divided into blocks, such as macroblock (MB) or LCU/CU to apply video coding. Video coding standards usually adopt adaptive Inter/Intra prediction on a block basis.

FIG. 1 illustrates an exemplary adaptive Inter/Intra video coding system incorporating loop processing. For Inter-prediction, Motion Estimation (ME)/Motion Compensation (MC) 112 is used to provide prediction data based on video data from other picture or pictures. Switch 114 selects Intra Prediction 110 or Inter-prediction data and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion, coding modes, and other information associated with the image area. The side information may also be compressed by entropy coding to reduce required bandwidth. Accordingly, the data associated with the side information are provided to Entropy Encoder 122 as shown in FIG. 1. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1, incoming video data undergoes a series of processing in the encoding system. The reconstructed video data from REC 128 may be subject to various impairments due to a series of processing. Accordingly, Loop filter 130 is often applied to the reconstructed video data before the reconstructed video data are stored in the Reference Picture Buffer 134 in order to improve video quality. For example, deblocking filter (DF) and Sample Adaptive Offset (SAO) have been used in the High Efficiency Video Coding (HEVC) standard. The loop filter information may have to be incorporated in the bitstream so that a decoder can properly recover the required information. Therefore, loop filter information is provided to Entropy Encoder 122 for incorporation into the bitstream. In FIG. 1, Loop filter 130 is applied to the reconstructed video before the reconstructed samples are stored in the reference picture buffer 134. The system in FIG. 1 is intended to illustrate an exemplary structure of a typical video encoder. It may correspond to the High Efficiency Video Coding (HEVC) system, VP8, VP9 or H.264.

FIG. 2 illustrates a system block diagram of a corresponding video decoder for the encoder system in FIG. 1. Since the encoder also contains a local decoder for reconstructing the video data, some decoder components are already used in the encoder except for the entropy decoder 210. Furthermore, only motion compensation 220 is required for the decoder side. The switch 146 selects Intra-prediction or Inter-prediction and the selected prediction data are supplied to reconstruction (REC) 128 to be combined with recovered residues. Besides performing entropy decoding on compressed residues, entropy decoding 210 is also responsible for entropy decoding of side information and provides the side information to respective blocks. For example, Intra mode information is provided to Intra-prediction 110, Inter mode information is provided to motion compensation 220, loop filter information is provided to loop filter 130 and residues are provided to inverse quantization 124. The residues are processed by IQ 124, IT 126 and subsequent reconstruction process to reconstruct the video data. Again, reconstructed video data from REC 128 undergo a series of processing including IQ 124 and IT 126 as shown in FIG. 2 and are subject to coding artifacts. The reconstructed video data are further processed by Loop filter 130.

For entropy coding, it comes in various flavors. Variable length coding is a form of entropy coding that has been widely used for source coding. Usually, a variable length code (VLC) table is used for variable length encoding and decoding. Arithmetic coding is a newer entropy coding technique that can exploit the conditional probability using “context”. Furthermore, arithmetic coding can adapt to the source statistics easily and provide higher compression efficiency than the variable length coding. While arithmetic coding is a high-efficiency entropy-coding tool and has been widely used in advanced video coding systems, the operations are more complicated than the variable length coding.

FIG. 3 illustrates an exemplary block diagram of the context-based adaptive binary arithmetic coding (CABAC) process. Since the arithmetic coder in the CABAC engine can only encode the binary symbol values, the CABAC process needs to convert the values of the syntax elements into a binary string using a binarizer (310). The conversion process is commonly referred to as binarization. During the coding process, the probability models are gradually built up from the coded symbols for the different contexts. The context modeler (320) serves the modelling purpose and the model is updated using decoded output data. Accordingly, a path 335 from the output of regular coding engine (330) to the context modeler (320) is provided. During normal context based coding, the regular coding engine (330) is used, which corresponds to a binary arithmetic coder. The selection of the modeling context for coding the next binary symbol can be determined by the coded information. Symbols can also be encoded without the context modeling stage and assume an equal probability distribution, commonly referred to as the bypass mode, for reduced complexity. For the bypassed symbols, a bypass coding engine (340) may be used. As shown in FIG. 3, switches (S1, S2 and S3) are used to direct the data flow between the regular CABAC mode and the bypass mode. When the regular CABAC mode is selected, the switches are flipped to the upper contacts. When the bypass mode is selected, the switches are flipped to the lower contacts.

Due to the high compression efficiency, it is desirable to take the advantage of arithmetic coding to improve performance of entropy coded video data.

### BRIEF SUMMARY OF THE INVENTION

A method for transcoding a compressed bitstream is disclosed. The system receives a first compressed bitstream generated by applying first entropy encoding to a set of tokens. The first compressed bitstream is decoded into the set of tokens using first entropy decoding corresponding to the first entropy encoding. The set of tokens is then re-encoded into a second compressed bitstream using second entropy encoding, where the second entropy encoding and the first entropy encoding use different statistics, different initial states, or both. The system may further comprising determining one or more modified or optimal probability models associated with the set of tokens, where the second entropy encoding is based on the modified or optimal probability models.

In one embodiment, the modified or optimal probability models can be determined based on context statistics received from a video encoder, and the context statistics are associated with tokens generated from source coding process comprising motion estimation, motion compensation, transform, quantization, inverse quantization and/or inverse transform. For example, the video encoder may correspond to a VP9 or VP8 video encoder, and the first entropy encoding corresponds to a VP9 or VP8 arithmetic encoder. For the VP9 system, the modified or optimal probability models are updated using backward adaptation for each frame. The modified or optimal probability models based on (N−1)-th frame are used by the first entropy decoding and the modified or optimal probability models based on N-th frame are used by the second entropy encoding for the first compressed bitstream associated with N-th frame, and N in a positive integer. For the VP8 system, the modified or optimal probability models are updated for each frame. The modified or optimal probability models based on N-th frame are used by the second entropy encoding for the first compressed bitstream associated with N-th frame.

The method may further comprise deriving context statistics from the first compressed bitstream. The context statistics are associated with tokens generated from source coding process comprising motion estimation, motion compensation, transform, quantization, inverse quantization and/or inverse transform. The modified or optimal probability models are derived based on the context statistics derived.

In another embodiment, the first compressed bitstream is generated by a video encoder, the second entropy encoding and the first entropy encoding correspond to arithmetic coding, and the second entropy encoding and the first entropy encoding use different initial states. The video encoder may correspond to an H.264 or HEVC (high performance video coding) video encoder, and the first entropy encoding corresponds to an H.264 or HEVC arithmetic encoder. For the H.264 video encoder, one or more non-default initial state as indicated by cabac_init_idc for the second entropy encoding are evaluated and the best initial state among the non-default initial states and a default initial state achieving the best coding performance is selected for the second entropy encoding. For the HEVC video encoder, all initial states as indicated by cabac_init_flag for the second entropy encoding are evaluated and one initial state achieving best coding performance is selected for the second entropy encoding.

An apparatus for entropy transcoding of a compressed bitstream is also disclosed. The apparatus comprises a first entropy decoding unit to decode a first compressed bitstream into a set of tokens using first entropy decoding corresponding to first entropy encoding, and a second entropy encoding unit to encode the set of tokens into a second compressed bitstream using second entropy encoding, wherein the second entropy encoding and the first entropy encoding use different statistics, different initial states, or both. The apparatus may further comprise a probability synthesis unit to determine one or more modified or optimal probability models associated with the set of tokens. The second entropy encoding is based on the modified or optimal probability models. Furthermore, the apparatus may also comprise a probability synthesis unit to determine one or more modified or optimal probability models associated with the set of tokens, where the second entropy encoding is based on said one or more modified or optimal probability models.

### BRIEF DESCRIPTION OF THE DRAWINGS

FIG. 1 illustrates an exemplary adaptive Inter/Intra video encoding system incorporating transform, quantization and loop processing.

FIG. 2 illustrates an exemplary adaptive Inter/Intra video decoding system incorporating transform, quantization and loop processing.

FIG. 3 illustrates an exemplary block diagram of the context-based adaptive binary arithmetic coding (CABAC) process.

FIG. 4 illustrates an exemplary scenario where the entropy transcoder according to the present invention can be used.

FIG. 5 illustrates an exemplary flowchart for a coding system incorporating entropy transcoding according to an embodiment of the present invention.

FIG. 6 illustrates an example of 2-stage encoding process, where the first stage generates tokens/syntax elements corresponding to coding elements and the second stage applies entropy coding to the tokens/syntax elements generated.

FIG. 7 illustrates an example of entropy transcoder design for VP9 encoded bitstream according to an embodiment of the present invention.

FIG. 8 illustrates an example of entropy transcoder design for VP8 encoded bitstream according to an embodiment of the present invention.

FIG. 9 illustrates an example of entropy transcoder design for H.264 encoded bitstream according to an embodiment of the present invention.

FIG. 10 illustrates an example of entropy transcoder design for HEVC (High Efficiency Video Coding) encoded bitstream according to an embodiment of the present invention.

FIG. 11 illustrates an example of entropy transcoder design for VP9 encoded bitstream without access to encoder internal information according to an embodiment of the present invention.

FIG. 12 illustrates an example of entropy transcoder design for VP8 encoded bitstream without access to encoder internal information according to an embodiment of the present invention.

FIG. 13 illustrates an exemplary flowchart for a video coding system utilizing entropy transcoder according to an embodiment of the present invention to improve coding performance.

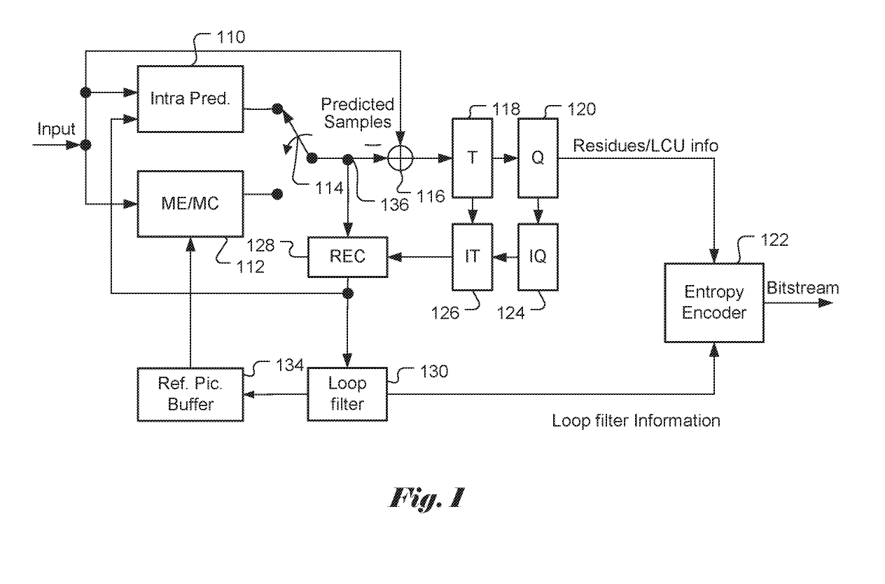

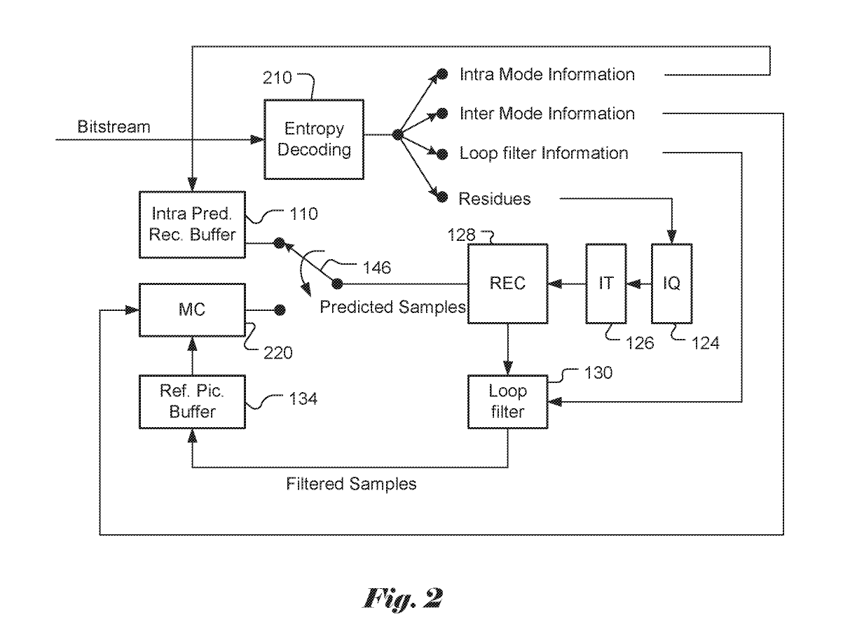

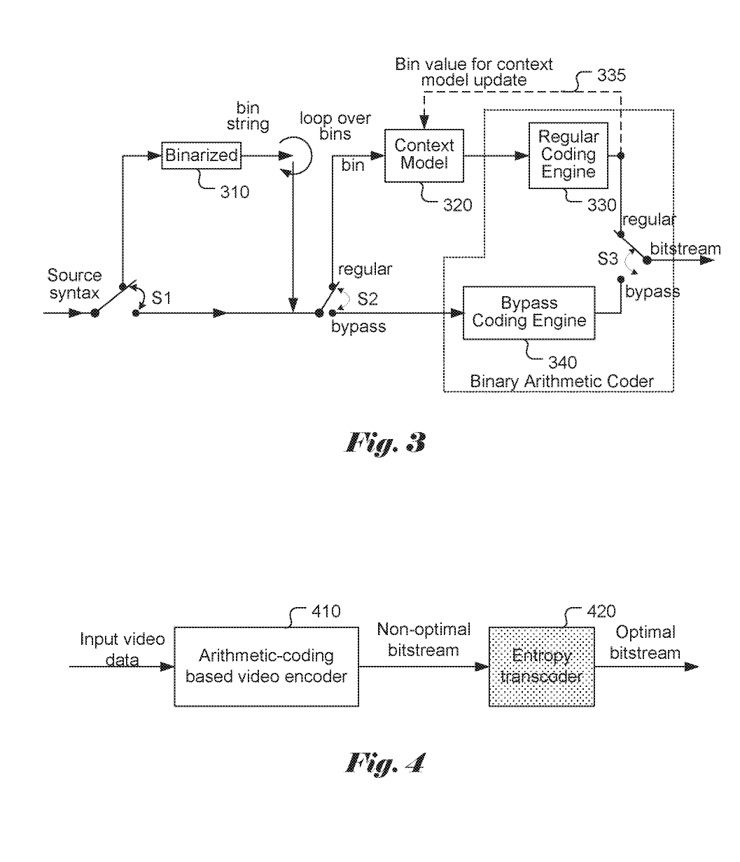

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned above, arithmetic coding is a high-efficiency entropy coding tool. Each symbol may be entropy coded with context so as to exploit some conditional probability of the current symbol with known context. Furthermore, arithmetic coding may use context model update process to adaptively adapt to the underlying statistics of the source symbols. At beginning of the arithmetic coding process, the statistics of the underlying source symbols may not be known yet. Therefore, an initial context model is used and hopefully the context update process will gradually converge to the true statistics.

While arithmetic coding has the capability to gradually adapt to the true statistic, the compression efficiency may be impacted by the choice of initial context model. There are rooms for improving the performance of arithmetic coding for already entropy coded data, including arithmetic coded data. The present invention discloses an entropy transcoding method to improve the performance of entropy coded data. FIG. 4 illustrates an exemplary scenario where the entropy transcoder according to the present invention can be used. The entropy transcoder 420 may accept input bitstream from a video decoder 410, where the video encoder uses arithmetic coding to compress at least some coding symbols or coding parameters. The entropy transcoder 420 will use a modified or optimized probability model to re-encode the previously encoded coding symbols or coding parameters in order to achieve improve coding efficiency. The use of entropy transcoder will involve additional data access and computations, which will result in higher data bandwidth and higher computation cost. However, the increase in bandwidth and computation cost may be offset by the improved coding efficiency. In addition, external storage for whole frame contexts may be reduced.

The video encoder 410 in FIG. 4 can be any video encoder that uses arithmetic coding. For example, the video encoder may correspond to AVC/H.264, HEVC/H.265, VP8 or VP9 video encoder. The entropy transcoder 420 shown in FIG. 4 may be implemented based on software (e.g., high-level program codes or digital signal processing (DSP) codes) or based on hardware (e.g., application specific integrated circuit (ASIC)). Furthermore, the use of the entropy transcoder can be enabled or disabled adaptively. For example, once power consumption is too high or processor/system resource is busy, the entropy transcoder can be disabled without causing any system failure. In this case, the system will just fall back to the original bitstream from the video encoder 410.

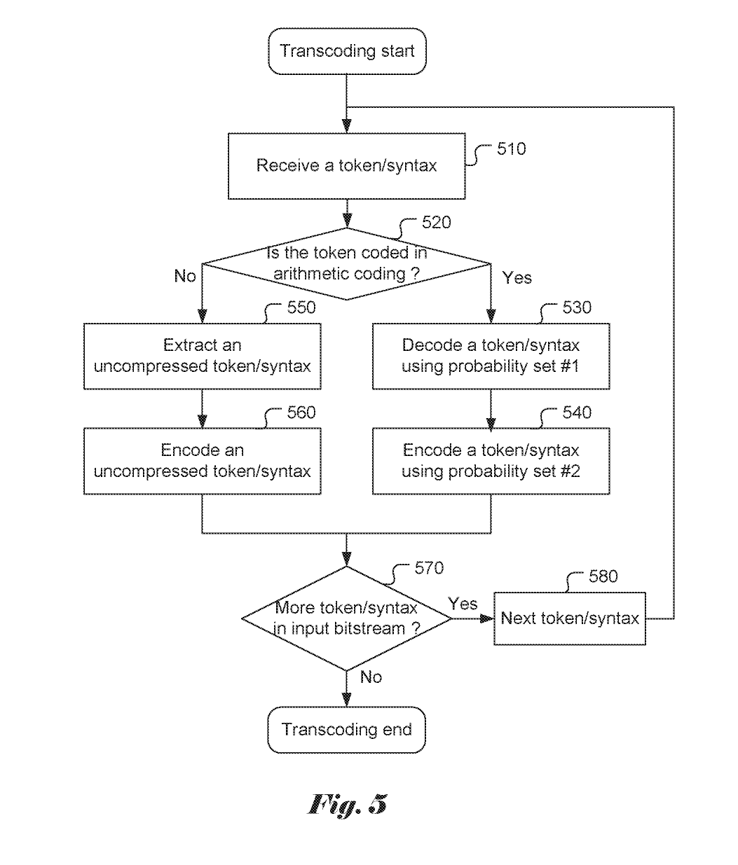

FIG. 5 illustrates an exemplary flowchart for a coding system incorporating entropy transcoding according to an embodiment of the present invention. The input to the process is a bitstream coded by entropy coding. The system retrieves a token/syntax in step 510 and determines whether the token/syntax is arithmetic coded as shown in step 520. If the underlying token/syntax is arithmetic coded (i.e., the “yes” path), processes in steps 530 and 540 will be performed. If the underlying token/syntax is not arithmetic coded (i.e., the “no” path), processes in steps 550 and 560 will be performed. In step 530, the arithmetic coded token/syntax will be decoded according to original probability model used by the original encoder. As mentioned before, the coding efficiency of the original arithmetic coding may not be as good as desired due to various reasons. The system according to the present invention will re-encode the tokens/syntax elements using arithmetic coding with a more accurate probability model and/or a better initial probability model. As shown in step 540. If the underlying token/syntax is not arithmetic coded, the token/syntax may be codes, which are uncompressed or compressed using variable length. The uncompressed token/syntax is extracted by, for example, being recovered in step 550. If the token/syntax is VLC coded, it will be decoded using a variable length decoder (VLD). In step 560, the token/syntax will be re-encoded using entropy coding. Arithmetic coding can be applied to the token/syntax in this branch to further improve coding efficiency. Nevertheless, the original VLC or a modified VLC may also be used for the token/syntax in this branch. In step 570, the system checks whether the token/syntax is the last one in the input. If the result is “yes”, the process is terminated. If the result is “no”, the process retrieve the next token/syntax as shown in step 580 and repeats the process at step 520. The tokens/syntax elements are also referred as coding elements in some literature.

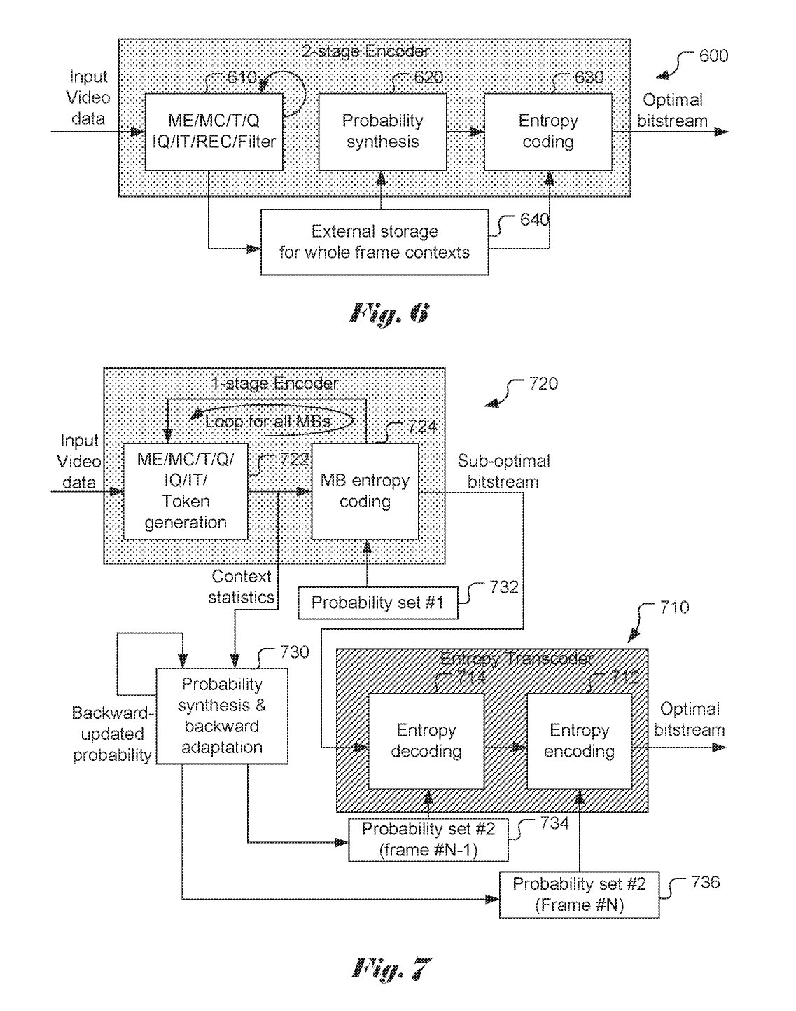

For VP8 and VP9, the encoder could use a 2-stage encoding process 600 as shown in FIG. 6, where the encoder applies the first-stage encoding process 610 to generate coding token/syntax. The first-stage encoding process 610 comprises motion estimation/motion compensation (ME/MC), transform (T), quantization (Q), inverse quantization (IQ), inverse transform (IT) and filter. The generated tokens/syntax elements for an image unit (e.g., a frame) are buffered in an external storage 640. After the tokens/syntax elements for a frame are accumulated, probability models with contexts for the tokens/syntax are generated using probability synthesis 620. The probability models from probability synthesis 620 are then provided to entropy coding 630 for encoding the token/syntax stored in the external storage 640.

The two stage encoder can achieve more efficient entropy coding since the probability models are derived based on the actual tokens/syntax elements generated. However, the 2-stage encoder requires to an additional buffer for the tokens/syntax elements of a frame being coded. Furthermore, to write out and read back the tokens/syntax elements generated will consume additional bandwidth. The probability modelling and the entropy re-encoding will consume additional computation power.

To save bandwidth and buffer, 1-stage encoder has been used by VP8 and VP9. The 1-stage encoder combines all the following processing, including motion estimation, motion compensation, transform, quantization, inverse quantization, inverse transform and entropy coding in a macroblock (MB)-based encoding loop. Since the statistics of the frame are not available during entropy coding, probability models used to generate the bitstream are not optimal.

Example of Entropy Transcoding for VP9

As mentioned above, the bitstream from a VP encoder is sub-optimal due to the 1-stage arrangement. An embodiment of the present invention can be applied to the output bitstream of the VP9 encoder to entropy transcode the bitstream using modified/optimal probability models to achieve improved performance.

Video content is inherently highly non-stationary in nature. In order to track the statistics of the various encoded symbols and update the parameters of the entropy coding contexts to match, VP9 makes use of forward context updates through the use of flags in the frame header that signal modifications of the coding contexts at the start of each frame. The syntax for forward updates is designed to allow an arbitrary sub-set of the node probabilities to be updated whilst leaving the others unchanged. Since no intermediate computations based on encountered token counts are necessary, the decoding speed can be substantially improved. Updates are encoded differentially, to allow a more efficient specification of updated coding contexts which is essential given the expanded set of tokens available in VP9.

In addition, VP9 also uses backward adaptation at the end of encoding each frame so that the impact on decoding speed is minimal. Specifically, for every frame encoded, first a forward update modifies the entropy coding contexts for various symbols encoded starting from the initial state at the beginning of the frame. Thereafter, all symbols encoded in the frame are coded using this modified coding state. At the end of the frame, both the encoder and decoder are expected to have accumulated counts for various symbols actually encoded or decoded over the frame. Using these actual distributions, a backward update step is applied to adapt the entropy coding context for use as the baseline for the next frame. In other words, the statistics collected for the current frame are used for entropy coding of the next frame in the backward adaptation mode.

As described above, the performance of entropy coding for VP9 is compromised in order to speed up the coding process, particularly the decoding speed. As mentioned earlier, the external storage requirement is another reason to use sub-optimal entropy coding for VP8 and VP9. In order to improve the performance of the entropy coding, an embodiment of the present invention uses probability synthesis and backward adaptation to improve or optimize the performance of the entropy re-encoding. The probability synthesis may be implemented as part of the entropy transcoder or external to the entropy transcoder. According to this embodiment, the probability synthesis doesn't rely on the probability model in the VP9 bitstream. Instead, the entropy transcoder will derive the probability models for coding each current frame based on the statistics of the current frame. The probability set for the entropy transcoding may be determined according to certain criteria such as cost optimization.

FIG. 7 illustrates an example of entropy transcoder design for VP9 encoded bitstream according to an embodiment of the present invention. The system block diagram also includes other related components, such as the VP9 encoder and various modules related to probability modelling. The entropy transcoder 710 comprises entropy re-encoding module 712 and entropy decoding module 714. The entropy decoding module 714 is used to decode an incoming bitstream comprising bitstream encoded by a sub-optimal entropy encoder. After the tokens/syntax elements are recovered by the entropy decoding module 714, the tokens/syntax elements are encoded by the entropy encoding module 712, which uses more accurate probability models to achieve better compression efficiency.

As mentioned above, VP9 updates the probability models in a backward fashion, where the statistics based on frame (N−1) is applied to encode frame N. However, the statistics from frame (N−1) may not match the statistics of frame N and compression efficiency will be degraded. As shown in FIG. 7, the input bitstream is generated by a 1-stage VP9 encoder 720, which comprises source coding module 722 and a MB entropy coding module 724. The source coding module 722 comprises motion estimation, motion compensation, transform, quantization, inverse quantization, inverse transform, token generation, any other type of source coding module or combination thereof. The MB entropy coding 724 uses an initial probability set 732 for Mb entropy coding. Within the 1-stage encoder, backward probability adaptation is performed to generate initial probability models for the next frame. In order for the entropy re-encoding to achieve improved compression performance, a probability synthesis and backward adaptation module 730 is used to provide probability models for the entropy decoding module 714 and entropy re-encoding module 712. The probability synthesis and backward adaptation module 730 receives context statistics from the video encoder 720. One probability set corresponds to probability models being used for the current frame N, which is derived based on the previous frame (i.e., N−1). This probability set is derived based on frame (N−1) for entropy decoding module 714 to decode the bitstream corresponding to the current frame N. The entropy decoding module 714 will output the recovered tokens/syntax elements for the current frame N, which will be entropy coded by the entropy re-encoder 712 using the probability set derived based on frame N.

The purpose of the probability synthesis is to find optimized probabilities for all tokens. The probability synthesis process is described as follows. For each token T, statistics of occurrence of T=1 and T=0 are collected. If the corresponding event counts are C(1) and C(0) respectively, the optimal probability Pₒₚₜ for T=1 is calculated as (C(1)/(C(0)+C(1)). The probability for T is updated to a new probability P_{new}, which is between the old probability P_{old} and the optimal probability Pₒₚₜ. The new probability P_{new} can be determined to minimize Bits_to_code_P_{new}+C(1)*Cost(P_{new})+C(0)*Cost(1−P_{new}) according to VP9. After the optimal probability Pₒₚₜ is determined, the probability is adapted from frame to frame according to P_{adapted}=Pₚᵣₑᵥ_{_}_{updated}*(256−R_{update})+Pₒₚₜ, where Pₚᵣₑᵥ_{_}_{updated} is the P_{adapted} of previous frame and R_{update} represents the rate of update.

Example of Entropy Transcoding for VP8

In VP8, probability table is assigned in the frame header. Syntax element is used to explicitly indicate whether the probability is updated or remains the same as the previous one. The backward adaptation used by VP9 is not available for VP8.

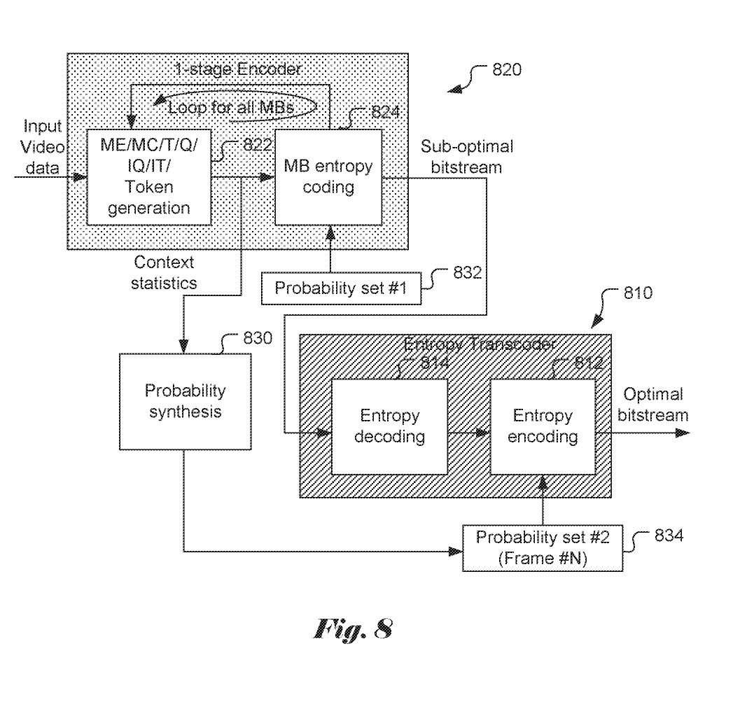

FIG. 8 illustrates an example of entropy transcoder design for VP8 encoded bitstream according to an embodiment of the present invention. The system block diagram also includes other related components, such as the VP8 encoder and various modules related to probability modelling. The entropy transcoder 810 comprises entropy re-encoding module 812 and entropy decoding module 814. The entropy decoding module 814 is used to decode an incoming bitstream comprising bitstream encoded by a sub-optimal entropy encoder. After the token/syntax are recovered by the entropy decoding module 814, the token/syntax are encoded by the entropy encoding module 812, which uses more accurate probability models to achieve better compression efficiency.

As shown in FIG. 8, the input bitstream is generated by a 1-stage VP8 encoder 820, which comprises source coding module 822 and a MB entropy coding module 824. The source coding module 822 comprises motion estimation, motion compensation, transform, quantization, inverse quantization, inverse transform, token generation, any other type of source coding module or combination thereof. The MB entropy coding 824 uses an initial probability set 832 for MB entropy coding.

As mentioned above, VP8 updates the probability models in a forward fashion, where the statistics based on frame (N−1) is applied to encode frame Nwithout using backward adaptation process. The probability update is signaled in the frame header. A probability synthesis module 830 is used to derive the probability set for the current frame based on context statistics of the current frame. The derived context probability set 834 is provided to the entropy re-encoding module 812 to encode the recovers tokens/syntax elements from the entropy decoding module 814.

In FIG. 8, the probability synthesis module 830 can be embedded into the entropy transcoder 810. The probability synthesis module 830 may also be external to the entropy transcoder 810.

Example of Entropy Transcoding for H.264

H.264 adopts context adaptive binary arithmetic coding (CABAC), which utilizes self-adaptive context modelling. While the CABAC is capable of self-adapting to the statistics of underlying video data, all models have to be re-initialized for each image unit, such as a slice by using some pre-defined probability states. The pre-defined probability states (i.e., cabac_init_idc) are used to give initial biases to the context variables. When entropy transcoder is used in H.264 encoding, an embodiment according to the present invention will evaluate all cabac_init_idc values and pick the one that achieves the best compression efficiency.

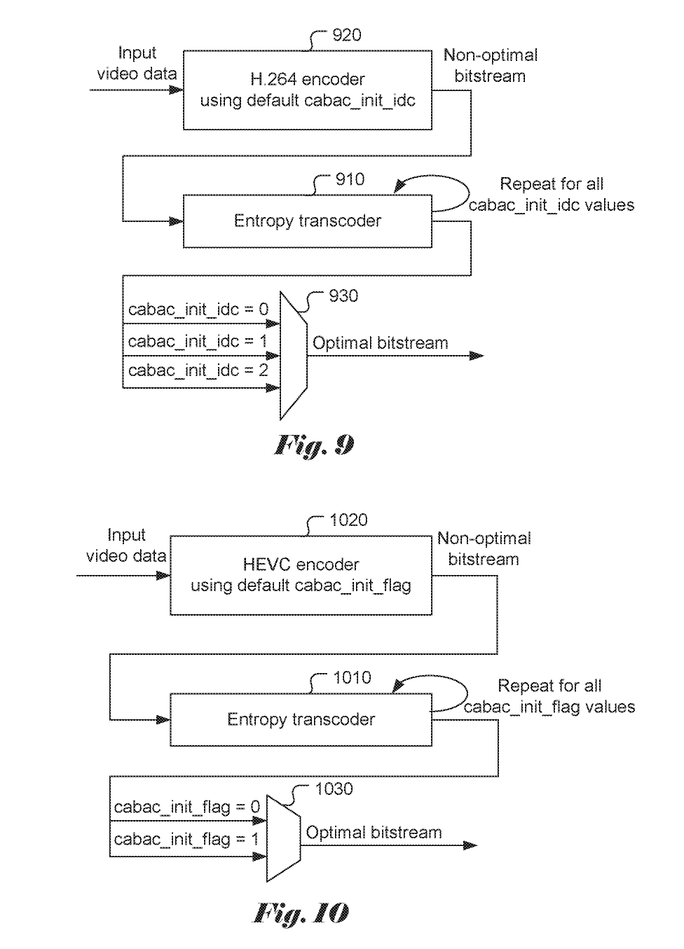

FIG. 9 illustrates an example of entropy transcoder design for H.264 encoded bitstream according to an embodiment of the present invention. The system block diagram also includes other related components, such as the H.264 encoder and other modules to support an embodiment of the present invention. The entropy transcoder 910 receives encoded bitstream from H.264 encoder 920, where a default cabac_init_idc is used. The entropy transcoder 910 will first decode the received H.264 bitstream using an H.264 decoder with the default cabac_init_idc to recover the tokens/syntax elements. The entropy transcoder then evaluates the resulted bitrate for all possible initial context tables and selects one that achieve the best compression efficiency. The optimal bitstream that is encoded using the best initial context tables (i.e., the best cabac_init_idc) is outputted from the entropy transcoder 910. In FIG. 9, a selector 930 is used to select the optimal bitstream as the final output. However, the selection may be made inside the entropy transcoder 910.

Example of Entropy Transcoding for HEVC/H.265

HEVC adopts similar context adaptive binary arithmetic coding (CABAC) as H.264. Initialization of context variables is controlled by a syntax element, cabac_init_flag. cabac_init_flag specifies the method for determining the initialization table used in the initialization process for context variables. An embodiment according to the present invention evaluates the bitrates associated with cabac_init_flag equal to 0 and equal to 1, and selects cabac_init_flag that achieves the best compression efficiency.

FIG. 10 illustrates an example of entropy transcoder design for HEVC encoded bitstream according to an embodiment of the present invention. The system block diagram also includes other related components, such as the HEVC encoder and other modules to support an embodiment of the present invention. The entropy transcoder 1010 receives encoded bitstream from HEVC encoder 1020, where a default cabac_init_flag is used. The entropy transcoder 1010 will first decode the received HEVC bitstream using an HEVC decoder with the default cabac_init_flag to recover the tokens/syntax elements. The entropy transcoder then evaluates the resulted bitrate for both cabac_init_flag equal to 0 and equal to 1, and selects one that achieve the best compression efficiency. The optimal bitstream that is encoded using the best initial context tables (i.e., the best cabac_init_flag) is outputted from the entropy transcoder 1010. In FIG. 10, a selector 1030 is used to select the optimal bitstream as the final output. However, the selection may be made inside the entropy transcoder 1010.

In the above examples, it assumes that the entropy transcoder is able to receive needed information to derive improved or optimal probability models to re-encode the tokens/syntax elements in order to improve the compression efficiency. It implies that the entropy transcoder have access to some information internal to the video encoder for deriving the improved or optimal probability models. For example, the entropy transcoder has access to context statistics in the cases for VP8 and VP9. However, the entropy transcoder may not always have access to some information internal to the video encoder. For example, the video files downloaded from websites represent video data that have been generated and outputted from an encoder. There is no way to get access to the information internal to the video encoder. In the case of video streaming from a broadcast side, on the generated output bitstream is available without knowing information internal to the video encoder. In such cases, the information used to derive the improved/optimal statistic models has to be derived from the received bitstreams.

Accordingly, in another embodiment of the present invention, the information required to derive improved/optimal probability models are derived from the received bitstream. The probability models are derived by analyzing the received bitstream. In order to analyze the received bitstream, the stream needed to be decoded into tokens/syntax elements using syntax decoder. The syntax may be encoded in entropy coding. Therefore, entropy decoding may be required to recover the tokens/syntax elements. Statistics of the tokens/syntax elements are accumulated. After the statistics are accumulated, optimal probability tables (i.e., optimal probability models) can be established and used for re-encoding the recovered tokens/syntax elements.

Example of Entropy Transcoding for VP9 without Access to Encoder Internal Information

As mentioned above, the bitstream from a VP9 encoder is sub-optimal due to the 1-stage arrangement. An embodiment of the present invention can be applied to the output bitstream of the VP9 encoder to entropy transcode the bitstream using modified/optimal probability models to achieve improved performance.

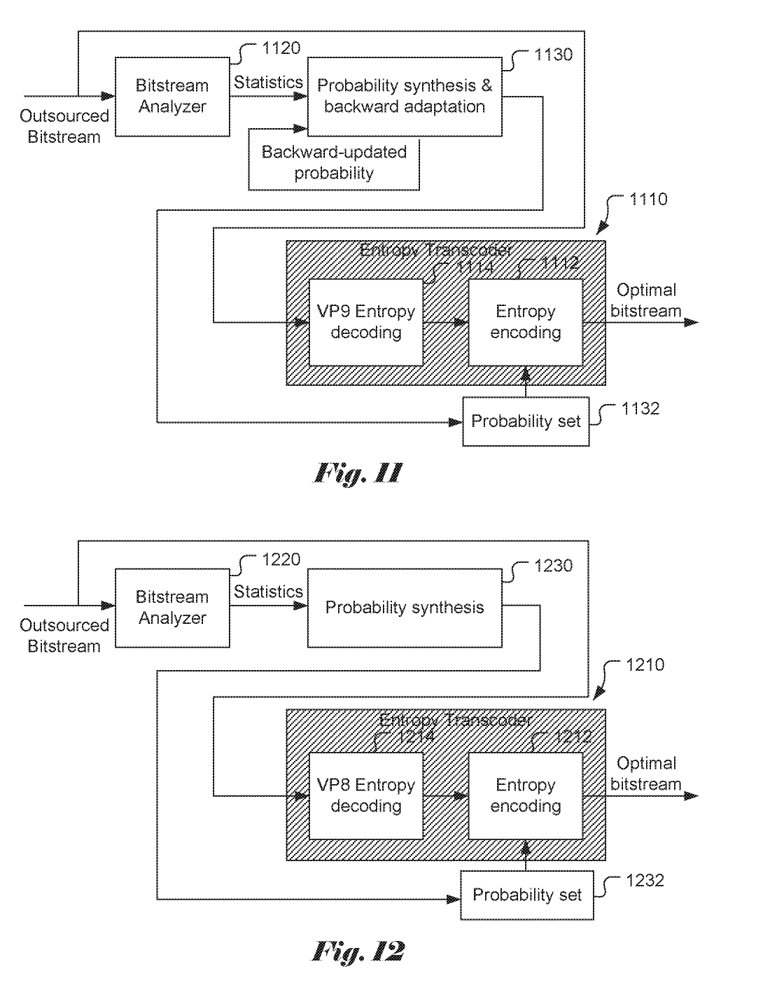

FIG. 11 illustrates an example of entropy transcoder design for VP9 encoded bitstream without access to encoder internal information according to an embodiment of the present invention. The entropy transcoder 1110 comprises entropy encoding module 1112 and VP9 entropy decoding module 1114. The VP9 entropy decoding module 1114 is used to decode an incoming bitstream comprising bitstream encoded by a sub-optimal entropy encoder. After the tokens/syntax elements are recovered by the entropy decoding module 1114, the tokens/syntax elements are encoded by the entropy re-encoding module 1112, which uses more accurate probability models to achieve better compression efficiency. The system block diagram also includes other related components, such as bitstream analyzer 1120 and probability synthesis and backward adaptation 1130. The bitstream analyzer 1120 is used to analyze the received bitstream and may include a syntax decoder as mentioned above. The probability set 1132 derived by the probability synthesis and backward adaptation 1130 is provided to the entropy re-encoding module 1112 for re-encoding the recovered tokens/syntax elements.

Example of Entropy Transcoding for VP8 without Access to Encoder Internal Information

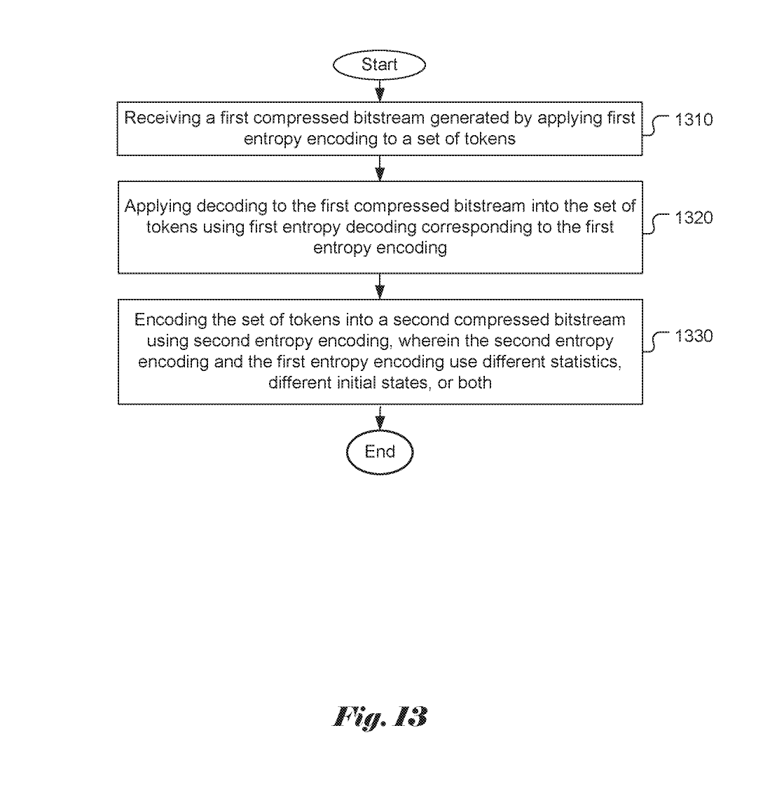

FIG. 12 illustrates an example of entropy transcoder design for VP8 encoded bitstream without access to encoder internal information according to an embodiment of the present invention. The entropy transcoder 1210 comprises entropy re-encoding module 1212 and VP8 entropy decoding module 1214. The entropy decoding module 1214 is used to decode an incoming bitstream comprising bitstream encoded by a sub-optimal entropy encoder. After the tokens/syntax elements are recovered by the VP8 entropy decoding module 1214, the tokens/syntax elements are encoded by the entropy re-encoding module 1212, which uses more accurate probability models to achieve better compression efficiency. The system block diagram also includes other related components, such as bitstream analyzer 1220 and probability synthesis 1230. The bitstream analyzer 1220 is used to analyze the received bitstream and may include a syntax decoder as mentioned above. The probability set 1232 derived by the probability synthesis and backward adaptation 1230 is provided to the entropy re-encoding module 1212 for re-encoding the recovered tokens/syntax elements.

FIG. 13 illustrates an exemplary flowchart for a video coding system utilizing entropy transcoder according to an embodiment of the present invention to improve coding performance. A first compressed bitstream generated by applying first entropy encoding to a set of tokens is received in step 1310. The first compressed bitstream is decoded into the set of tokens using first entropy decoding corresponding to the first entropy encoding as shown in step 1320. The set of tokens is then re-encoded into a second compressed bitstream using second entropy encoding in step 1330, where the second entropy encoding and the first entropy encoding use different statistics, different initial states, or both.

The flowchart shown is intended to illustrate an example of entropy transcoding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The present invention discloses a high-throughput entropy decoder for arithmetic coded bin strings. The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of entropy transcoding for a compressed bitstream, comprising:
receiving a first compressed bitstream generated by applying first entropy encoding to a set of tokens;
decoding the first compressed bitstream into the set of tokens using first entropy decoding corresponding to the first entropy encoding; and
encoding the set of tokens into a second compressed bitstream using second entropy encoding, wherein the second entropy encoding and the first entropy encoding use different statistics, different initial states, or both.

2. The method of claim 1, further comprising determining one or more modified or optimal probability models associated with the set of tokens, wherein the second entropy encoding is based on said one or more modified or optimal probability models.

3. The method of claim 2, wherein said determining said one or more modified or optimal probability models is based on context statistics received from a video encoder, and the context statistics are associated with tokens generated from source coding process comprising motion estimation, motion compensation, transform, quantization, inverse quantization and/or inverse transform.

4. The method of claim 3, wherein the video encoder corresponds to a VP9 video encoder, the first entropy encoding corresponds to a VP9 arithmetic encoder.

5. The method of claim 3, wherein said determining said one or more modified or optimal probability models uses backward adaptation to update said one or more modified or optimal probability models for each frame, said one or more modified or optimal probability models based on (N−1)-th frame are used by the first entropy decoding and said one or more modified or optimal probability models based on N-th frame are used by the second entropy encoding for the first compressed bitstream associated with N-th frame, and N in a positive integer.

6. The method of claim 3, wherein the video encoder corresponds to a VP8 video encoder, the first entropy encoding corresponds to a VP8 arithmetic encoder.

7. The method of claim 2, wherein said determining said one or more modified or optimal probability models updates said one or more modified or optimal probability models for each frame, said one or more modified or optimal probability models based on N-th frame are used by the second entropy encoding for the first compressed bitstream associated with N-th frame, and N in a positive integer.

8. The method of claim 2, further comprising deriving context statistics from the first compressed bitstream, wherein the context statistics are associated with tokens generated from source coding process comprising motion estimation, motion compensation, transform, quantization, inverse quantization and/or inverse transform, and wherein said determining said one or more modified or optimal probability models is based on the context statistics derived.

9. The method of claim 8, wherein the first compressed bitstream is generated by a video encoder corresponding to a VP9 video encoder, and the first entropy encoding corresponds to a VP9 arithmetic encoder.

10. The method of claim 8, wherein the first compressed bitstream is generated by a video encoder corresponding to a VP8 video encoder, and the first entropy encoding corresponds to a VP8 arithmetic encoder.

11. The method of claim 10, wherein said determining said one or more modified or optimal probability models updates said one or more modified or optimal probability models for each frame, said one or more modified or optimal probability models based on N-th frame are used by the second entropy encoding for the first compressed bitstream associated with N-th frame, and N in a positive integer.

12. The method of claim 2, wherein said determining said one or more modified or optimal probability models uses backward adaptation to update said one or more modified or optimal probability models for each frame and said one or more modified or optimal probability models based on N-th frame are used by the second entropy encoding for the first compressed bitstream associated with N-th frame, and N in a positive integer.

13. The method of claim 12, wherein said determining said one or more modified or optimal probability models is based on context statistics received from an H.264 video encoder, the first entropy encoding corresponds to an H.264 arithmetic encoder.

14. The method of claim 12, wherein said determining said one or more modified or optimal probability models is based on context statistics received from a HEVC (high performance video coding) video encoder, the first entropy encoding corresponds to an HEVC arithmetic encoder.

15. The method of claim 1, wherein the first compressed bitstream is generated by a video encoder, the second entropy encoding and the first entropy encoding correspond to arithmetic coding, and the second entropy encoding and the first entropy encoding use different initial states.

16. The method of claim 1, wherein one or more non-default initial states as indicated by cabac_init_idc for the second entropy encoding are evaluated and a best initial state among said one or more initial states and a default initial state achieving best coding performance is selected for the second entropy encoding.

17. The method of claim 1, wherein all initial states as indicated by cabac_init_flag for the second entropy encoding are evaluated and one initial state achieving best coding performance is selected for the second entropy encoding.

18. An apparatus for entropy transcoding of a compressed bitstream, comprising:
a first entropy decoding unit to decode a first compressed bitstream into a set of tokens using first entropy decoding corresponding to first entropy encoding; and
a second entropy encoding unit to encode the set of tokens into a second compressed bitstream using second entropy encoding, wherein the second entropy encoding and the first entropy encoding use different statistics, different initial states, or both.

19. The apparatus of claim 18, further comprising a probability synthesis unit to determine one or more modified or optimal probability models associated with the set of tokens, wherein the second entropy encoding is based on said one or more modified or optimal probability models.

20. The apparatus of claim 19, wherein the probability synthesis unit determines said one or more modified or optimal probability models based on context statistics received from a video encoder, and the context statistics are associated with tokens generated from source coding process comprising motion estimation, motion compensation, transform, quantization, inverse quantization and/or inverse transform.

21. The apparatus of claim 20, wherein the video encoder corresponds to a VP9 video encoder, the first entropy encoding corresponds to a VP9 arithmetic encoder.

22. The apparatus of claim 20, wherein the video encoder corresponds to a VP8 video encoder, the first entropy encoding corresponds to a VP8 arithmetic encoder.

23. The apparatus of claim 19, wherein the probability synthesis unit determines said one or more modified or optimal probability models uses backward adaptation to update said one or more modified or optimal probability models for each frame, said one or more modified or optimal probability models based on (N−1)-th frame are used by the first entropy decoding and said one or more modified or optimal probability models based on N-th frame are used by the second entropy encoding for the first compressed bitstream associated with N-th frame, and N in a positive integer.

24. The apparatus of claim 19, wherein the probability synthesis unit determines said one or more modified or optimal probability models updates said one or more modified or optimal probability models for each frame, said one or more modified or optimal probability models based on N-th frame are used by the second entropy encoding for the first compressed bitstream associated with N-th frame, and N in a positive integer.

25. The apparatus of claim 19, further comprising a bitstream analyzer unit to receive the first compressed bitstream, to derive context statistics from the first compressed bitstream and to provide the context statistics to the probability synthesis unit, wherein the context statistics are associated with tokens generated from source coding process comprising motion estimation, motion compensation, transform, quantization, inverse quantization and/or inverse transform, and wherein the probability synthesis unit determines said one or more modified or optimal probability models is based on the context statistics derived.

26. The apparatus of claim 25, wherein the first compressed bitstream is generated by a video encoder corresponding to a VP9 video encoder, and the first entropy encoding corresponds to a VP9 arithmetic encoder.

27. The apparatus of claim 25, wherein the first compressed bitstream is generated by a video encoder corresponding to a VP8 video encoder, and the first entropy encoding corresponds to a VP8 arithmetic encoder.

28. The apparatus of claim 19, wherein the probability synthesis unit determines said one or more modified or optimal probability models uses backward adaptation to update said one or more modified or optimal probability models for each frame and said one or more modified or optimal probability models based on N-th frame are used by the second entropy encoding for the first compressed bitstream associated with N-th frame, and N in a positive integer.

29. The apparatus of claim 19, wherein he probability synthesis unit determines said one or more modified or optimal probability models updates said one or more modified or optimal probability models for each frame, said one or more modified or optimal probability models based on N-th frame are used by the second entropy encoding for the first compressed bitstream associated with N-th frame, and N in a positive integer.

30. The apparatus of claim 18, wherein the first compressed bitstream is generated by a video encoder, the second entropy encoding and the first entropy encoding correspond to arithmetic coding, and the second entropy encoding and the first entropy encoding use different initial states.

31. The apparatus of claim 30, wherein the video encoder corresponds to an H.264 video encoder, the first entropy encoding corresponds to an H.264 arithmetic encoder.

32. The apparatus of claim 30, wherein the video encoder corresponds to a HEVC (high performance video coding) video encoder, the first entropy encoding corresponds to an HEVC arithmetic encoder.

33. The apparatus of claim 18, wherein one or more non-default initial states as indicated by cabac_init_idc for the second entropy encoding are evaluated and a best initial state among said one or more non-default initial states and a default initial state achieving best coding performance is selected for the second entropy encoding.

34. The apparatus of claim 18, wherein all non-default initial states as indicated by cabac_init_flag for the second entropy encoding are evaluated and one non-default initial state achieving best coding performance is selected for the second entropy encoding.
